(19) United States
(12) Patent Application Publication
(10) Pub. No.: US 2016/0340137 A1
(43) Pub. Date: Nov. 24, 2016

(54) TRANSFER DEVICE FOR SUBSTRATE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Xuan CHEN, Beijing (CN); Fangming LI, Beijing (CN); Yadong GAO, Beijing (CN)

(21) Appl. No.: 15/098,933

(22) Filed: Apr. 14, 2016

(30) Foreign Application Priority Data
May 21, 2015 (CN) 201510262964.8

(51) Int. Cl. B65H 9/00; B65H 15/00; B25J 11/00; B65G 47/244; B65G 47/248

(52) U.S. Cl. CPC B65H 9/00; B65G 47/244; B65G 47/248; B25J 11/00; B65H 15/00; B65H 2301/332; B65H 2301/333

(57) ABSTRACT

Disclosed is a transfer device for substrate to solve the problem in the prior art. The device includes: a support body, a movable support connected to the support body, and an access support for cooperating with the movable support to pick up and place the substrate. The support body includes vertical and bottom plates which are perpendicular to each other, The movable support includes a support beam rotatably connected to the support body; the movable support further includes a rotary rack rotatably connected to the support beam; the rotary rack drives the substrate to rotate within a plane of the rotary rack; and the support beam drives the substrate on rotary rack to flip. Since the rotary rack can rotate with respect to the support beam and the support beam can rotate with respect to the support body, the substrate on the rotary rack can rotate and flip.

### CROSS-REFERENCE TO RELATED APPLICATION

This application claims the priority of Chinese Patent Application No. 201510262964.8 filed on May 21, 2015, titled “Transfer device for substrate” in the Chinese Intellectual Property Office, the disclosure of which is incorporated herein by reference.

### FIELD OF THE INVENTION

The disclosure relates to the field of display technologies, and in particular to a transfer device for substrate.

### BACKGROUND OF THE INVENTION

As shown in FIG. 1, the manufacturing process of liquid crystal panel is complicated, in which a substrate is needed to be machined on a number of production lines. In the process, the substrate may be necessarily removed or transferred due to a testing of equipment, an inspection of substrate, a handling of fault, etc,. Since the substrate has characteristics of a large area, a thin thickness and a low weight, a device for transferring the substrate has existed in the prior art.

FIG. 1 is a structural diagram of a transfer device for substrate in the prior art. The transfer device for substrate in the prior art may substantially include a support body I and a movable support 2 which is attached to the support body 1 and movable on a vertical plate 11 of the support body 1 in upward and downward directions, The vertical plate 11 is connected to a bottom plate 12 and supported by the bottom plate 12. The movable support 2 may include a support shaft 14 used to connect the movable support 2 to the vertical plate 11, and can be moved upward and downward on the vertical plate 11 by driving the support shaft 14 with a first lifting unit. It should be understood that the first lifting unit may include a belt, a rocker gear and a planner plate with a tooth surface. The rocker gear may drive the belt to rotate and then the belt may drive the planner plate to ascend or descend.

A guide rail 13 is provided and fixedly attached to the vertical plate 11. The first lifting unit is connected to the support shaft 14 so as to drive the support shaft 14 to ascend or descend. The first lifting unit may also be embodied in other forms.

The transfer device for substrate in the prior art may further include an access support 3 which cooperates with the movable support 2. The access support 3 may be provided with a second lifting unit and positioned correspondingly to a support for substrate transmission 4. When there is a need to access to a substrate on the transmission support 4, the second lifting unit of the access support 3 may ascend to lift the substrate up from the underneath of the transmission support 4. At this point, driven by the first unit, the movable support 2 may be moved into a position just underneath the access support 3. Then, the first lifting unit may lift the movable support 2 up. The movable support 2 may hold up the substrate placed on the access support 3. Then, the support body 1 may be moved to transfer the substrate to another apparatus. It should be understood that the apparatus is also equipped with an access support 3 and a second lifting unit. In the second lifting unit, gas cylinder or hydraulic cylinder drive well known by those skilled in the art may be employed.

The movable support 2 may be in the shape of fork and make pick-and-place across the access support 3 in a single direction, In other words, the movable support 2 can be moved only in a longitudinal direction thereof. However, on the production line for manufacturing the liquid crystal display panel, the substrate necessarily has a relative position (posture) following defined requirements when it is machined on each apparatus. Therefore, when there is a need to pick up the substrate from one apparatus to another apparatus, sometimes the substrate is required to change its posture or be flipped over. The transfer device for substrate in the prior art cannot realize above functions. As a result, the substrate can only be rotated or flipped over manually or by means of a special auxiliary tool (for example, a turnover device). This may cause quality or security problems.

### SUMMARY OF THE INVENTION

To address above problems, the disclosure provides a transfer device for substrate, including: a support body, a movable support connected to the support body, and an access support for cooperating with the movable support to pick up and place the substrate, the support body including a vertical plate and a bottom plate which are perpendicular to each other, wherein the movable support includes a support beam rotatably connected to the support body; the movable support further includes a rotary rack rotatably connected to the support beam; the rotary rack is configured to drive the substrate to rotate within a plane of the rotary rack; and the support beam is configured to drive the substrate on the rotary rack to flip over.

Preferably, the support beam is connected to the support body via a first rotary shaft, such that the support beam is able to rotate about the first rotary shaft with respect to the support body.

Preferably, the rotary rack is connected to the support beam via a second rotary shaft, such that the rotary rack is able to rotate about the second rotary shaft with respect to the support beam.

Preferably, the rotary rack is able to move in a longitudinal direction of the support beam to adjust a distance between the rotary rack and the support body.

Preferably, a sliding slot is provided on the support beam in the longitudinal direction; and the second rotary shaft is able to fit to the sliding slot at one end thereof and move along the sliding slot.

Preferably, the sliding slot further includes an internal expansion space which is expended inside the support beam along a width direction; and the second rotary shaft includes a flange which is fitted to the internal expansion space.

Preferably, the first rotary shaft is provided with a first locating disk between the support body and the support beam; the first locating disk includes a plurality of locating notches arranged in a peripheral direction thereof; and a first stop pin is provided on the support body, such that the rotation angle of the first rotary shaft is controlled by the cooperation between the first stop pin and the locating notches.

Preferably, the second rotary shaft is provided with a second locating disk between the rotary rack and the support beam; the second locating disk includes a plurality of locating notches arranged in a peripheral direction thereof; and a second stop pin is provided on the support beam, such that a rotation angle of the second rotary shaft is controlled by the cooperation between the second stop pin and the locating notches.

Preferably, the first stop pin is provided with an elastic element for exerting force in direction of the first locating notch on the first stop pin.

Preferably, the second stop pin is provided with an elastic element for exerting force in direction of the second locating notch on the second stop pin.

Preferably, the rotary rack includes a primary support bar and auxiliary support bars which are arranged perpendicularly to the primary support bar; and the rotary rack is symmetrical about the second rotary shaft.

Preferably, the auxiliary support bars are provided with a plurality of adsorption parts for adsorbing the substrate.

Preferably, the access support includes a top side for placing the substrate thereon and periphery sides surrounding the top side; and a common border between the top side and at least one of periphery sides adjacent to the vertical plate has a gap for the support beam to pass through.

Preferably, opposite borders of the top side has a plurality of additional rods, respectively, which are arranged at intervals and extended inwardly; a clearance is defined between two oppositely arranged additional rods for the primary support bar to pass through; and a spacer region is defined between two adjacent additional rods on the same border for the auxiliary support bars to pass through.

In the transfer device for substrate according to the disclosure, since the rotary rack can rotate with respect to the support beam and the support beam can rotate with respect to the support body, the substrate can be driven to rotate and/or flip when it is placed on the rotary rack, thereby realizing the transfer and rotation of the substrate.

### BRIEF DESCRIPTION OF THE DRAWINGS

FIG. 1 is a structural schematic diagram of a transfer device for substrate in the prior art;

FIG. 2 is a structural schematic diagram of a transfer device for substrate in a state where a primary support bar of a rotary rack is perpendicular to a support beam according to an embodiment of the disclosure;

FIG. 3 is a structural schematic diagram of the transfer device for substrate in a state where the primary support bar of the rotary rack is parallel to the support beam according to the embodiment of the disclosure;

FIG. 4 is a structural schematic diagram of the transfer device for substrate in a state where the primary support bar of the rotary rack is perpendicular to the support beam and the rotary rack is flipped over according to the embodiment of the disclosure;

FIG. 5 is a structural schematic diagram of the transfer device for substrate in a state where a second rotary shaft is fitted to a sliding slot according to the embodiment of the disclosure;

FIG. 6 is a structural schematic diagram of the transfer device for substrate in a state where a stop pin is fitted to a locating disk according to the embodiment of the disclosure;

FIG. 7 is a structural schematic diagram of the transfer device for substrate in a state where a movable support cooperates with an access support (pick-and-place by a short side) according to the embodiment of the disclosure;

FIG. 8 is a structural schematic diagram of the transfer device for substrate in a state where a movable support cooperates with an access support (pick-and-place by a long side) according to the embodiment of the disclosure;

FIG. 9 is a structural schematic diagram of the transfer device for substrate in a state where the access support is lifted up from a transmission support (pick-and-place by a long side) according to the embodiment of the disclosure;

FIG. 10 is a schematic top plan diagram of the transfer device for substrate in a state where the movable support cooperates with the access support (pick-and-place by a short side) according to the embodiment of the disclosure; and

FIG. 11 is a schematic top plan diagram of the transfer device for substrate in a state where the access support is lifted up from transmission support (pick-and-place by a long side) according to the embodiment of the disclosure.

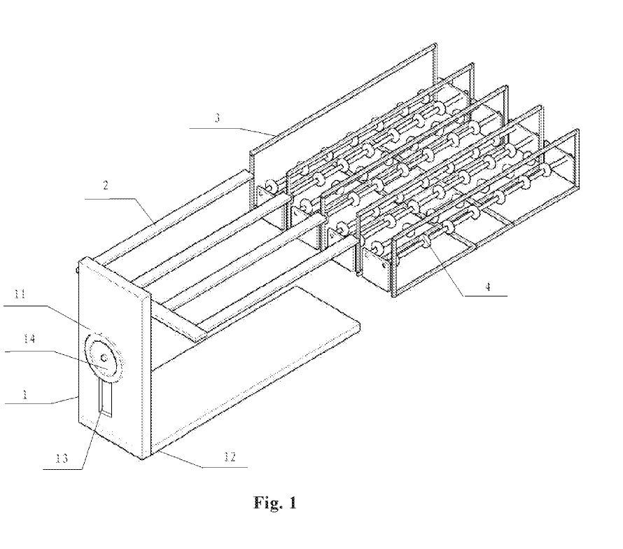

### Numeral Reference List

1—support body; 11—vertical plate; 12—bottom plate; 13—guide rail; 14—support shaft;

2—movable support; 21—support beam; 212—sliding slot; 2121—internal expansion space;

3—access support; 31—top side; 311—additional rod; 312—clearance; 313—spacer region;

32—periphery side; 321—gap;

4—transmission support;

22—rotary rack; 221—primary support bar; 222—auxiliary support bars; 2221—adsorption part;

5—first rotary shaft;

6—second rotary shaft; 61—flange;

7—first locating disk; 8—second locating disk; 9—locating notch;

10—stop pin; 101—pin tip; 102—spring

### DETAILED DESCRIPTION OF THE EMBODIMENTS

In order to better understand the technical solutions of the disclosure by those skilled in the art, the disclosure will be further described in detail in conjunction with the accompanying drawings and specific embodiments.

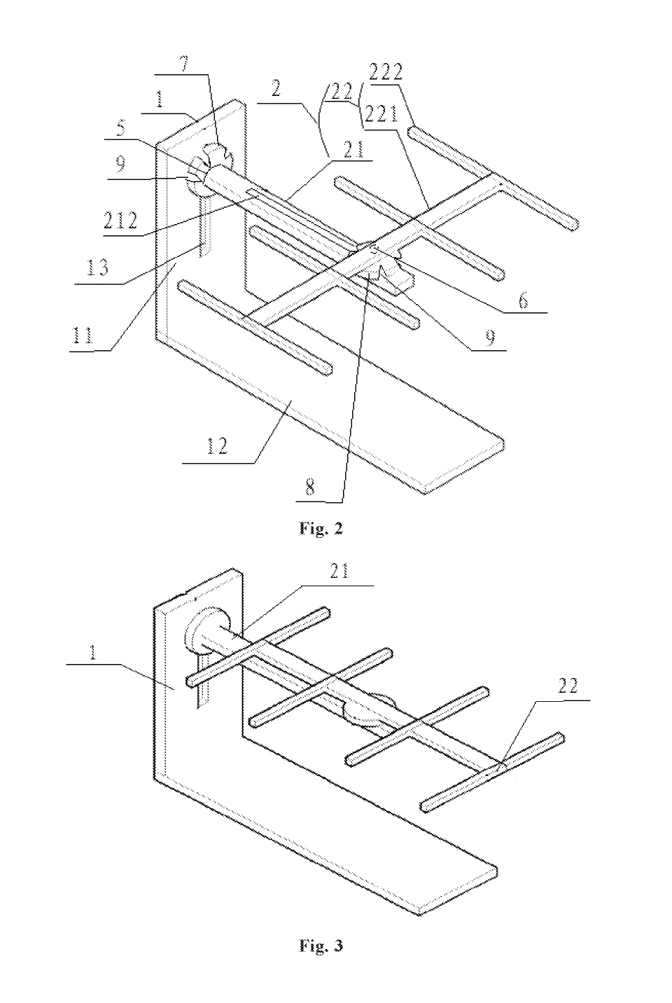

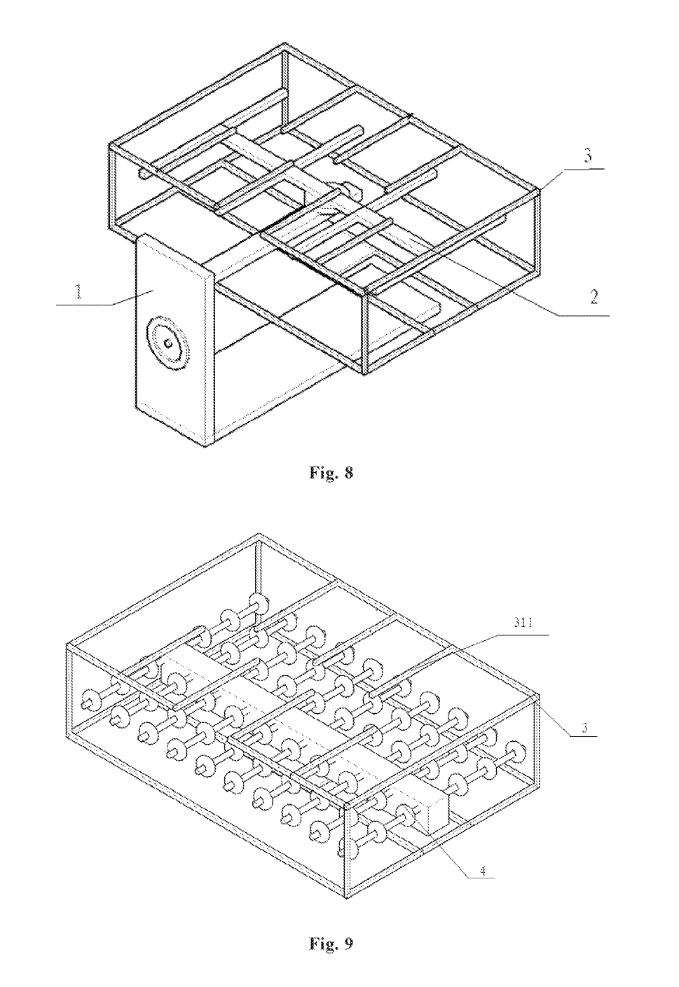

As shown in FIGS. 2-10, the embodiment of the disclosure provides a transfer device for substrate, including: a support body 1, a movable support 2 connected to the support body 1, and an access support 3 for cooperating with the movable support 2 to pick up and place a substrate. The support body 1 includes a vertical plate 11 and a bottom plate 12 which are perpendicular to each other.

The movable support 2 includes a support beam 21 rotatably connected to the support body 1; the movable support 2 further includes a rotary rack 22 rotatably connected to the support beam 21; the rotary rack 22 is configured to drive the substrate to rotate within a plane of the rotary rack 22; and the support beam 21 is configured to drive the substrate on the rotary rack 22 to flip over.

In the transfer device for substrate according to this embodiment, since the rotary rack is able to rotate with respect to the support beam and the support beam is able to rotate with respect to the support body, when the substrate is placed on the rotary rack, the substrate can be driven to rotate and/or flip, thereby realizing the transfer and rotation of the substrate.

It should be understood, as shown in FIG. 2, the support body 1 may further include the vertical plate 11. The movable support 2 is connected to the vertical plate 11 of the support body 1 and movable with respect to the vertical plate 11 in upward and downward directions. The vertical plate 11 is connected to the bottom plate 12 and supported by the bottom plate 12. Driven by the first lifting unit, the support beam 21 can be moved upward and downward on the vertical plate 11. The lifting unit is connected to the support beam and may drive the support beam 21 and rotary rack 22 to ascend or descend together. In addition, a guide rail 13 is provided on the vertical plate 11 and fixed attached thereto.

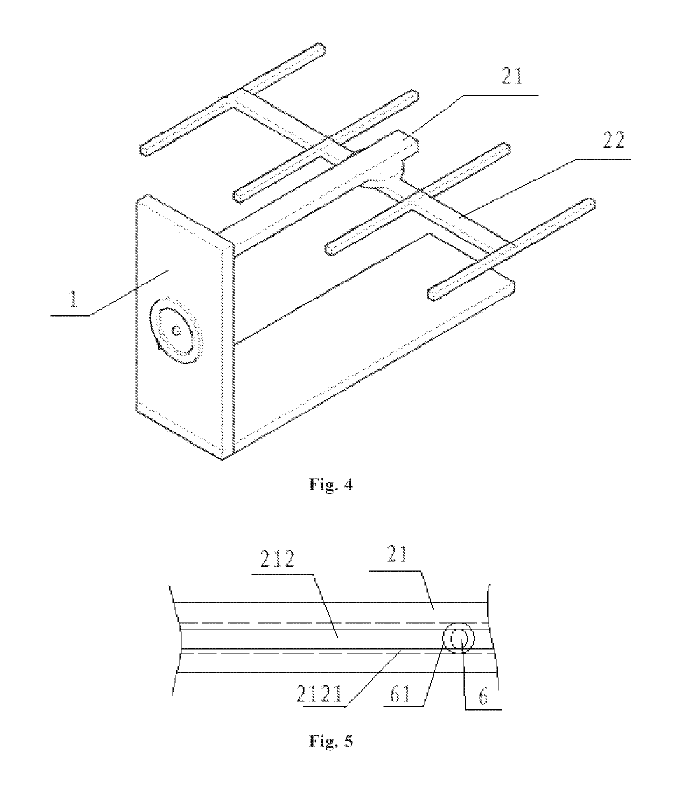

FIGS. 2 and 3 illustrate different relative angles between the rotary rack 22 and the support beam 21 in the horizontal plane; and FIG. 4 illustrates the rotary rack 22 in a flipped state.

Preferably, the support beam 21 is connected to the support body 1 via a first rotary shaft 5, such that the support beam 21 is able to rotate about the first rotary shaft 5 with respect to the support body 1. Since the rotary rack 22 is connected to the support beam 21, when the support beam 21 is rotated by an angle of 180 degrees, the rotary rack 22 can be flipped over.

Preferably, the rotary rack 22 is connected to the support beam 21 via a second rotary shaft 6, such that the rotary rack 22 is able to rotate about the second rotary shaft 6 with respect to the support beam 21.

Preferably, the rotary rack 22 is able to move in a longitudinal direction of the support beam 21 to adjust a distance between the rotary rack 22 and the support body 1.

In such a manner, the distance between the rotary rack 22 and the support body 1 can be adjusted in the longitudinal direction of the rotary rack 22, so that the support body 1 cannot interfere with the rotation of the rotary rack 22.

Preferably, a sliding slot 212 is provided on the support beam 21 in the longitudinal direction; and the second rotary shaft 6 is able to fit to the sliding slot 212 at one end thereof and move along the sliding slot 212.

Preferably, as shown in FIG, 5, the sliding slot 212 further includes an internal expansion space 2121 which is expended inside the support beam 21 along a width direction (a boundary of the internal expansion space 2121 is indicated by dashed lines in the drawing), and the second rotary shaft 6 includes a flange 61 which is fitted to the internal expansion space 2121. In such a manner, when the flange 61 is fitted to the internal expansion space 2121, the second rotary shaft 6 can smoothly move along the sliding slot 212. Further, in such a manner, the rotary rack 22 can be stably supported while moving with respect to the support beam 21.

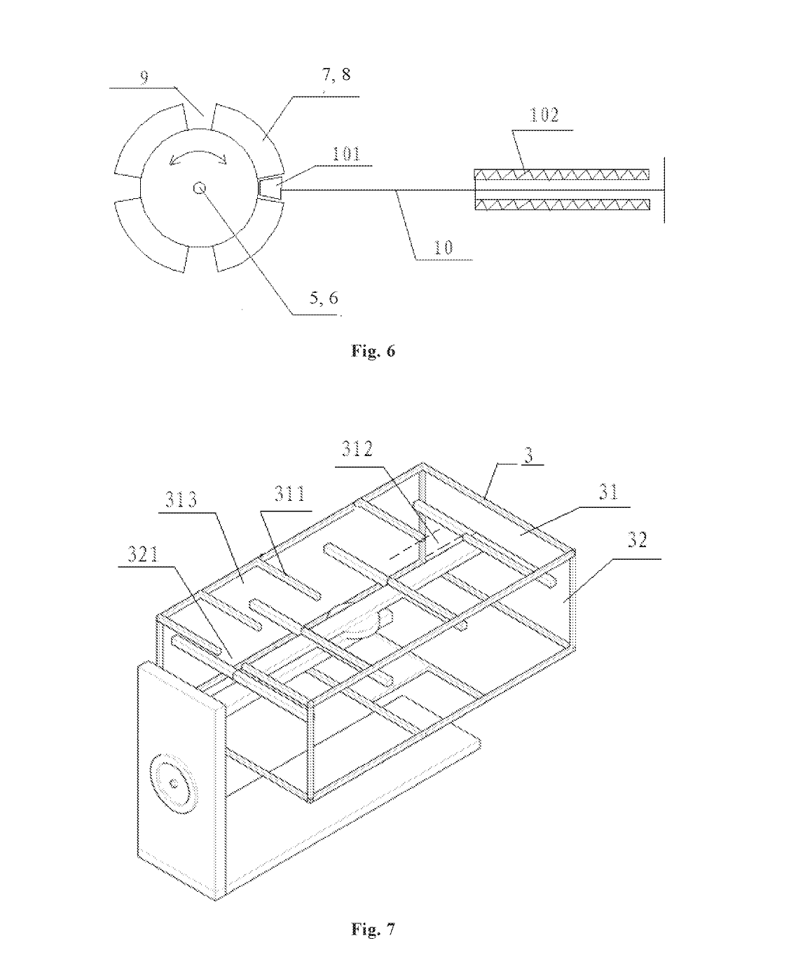

Preferably, the first rotary shaft 5 is provided with a first locating disk 7 between the support body 1 and the support beam 21; the first locating disk 7 includes a plurality of locating notches 9 arranged in a peripheral direction thereof; and a first stop pin (detailed structure of the stop pin is shown in FIG. 6) is provided on the support body 1, such that the rotation angle of the first rotary shaft 5 is controlled by the cooperation between the first stop pin and the locating notches 9.

Preferably, the second rotary shaft 6 is provided with a second locating disk 8 between the rotary rack 22 and the support beam 21; the second locating disk 8 includes a plurality of locating notches 9 arranged in a peripheral direction thereof; and a second stop pin (detailed structure of the stop pin is shown in FIG. 6) is provided on the support beam 21, such that the rotation angle of the second rotary shaft 6 is controlled by the cooperation between the second stop pin and the locating notches 9.

In particular, the structure of the stop pin 10 which is fitted to the first locating disk 7 or the second locating disk 8 is shown in FIG. 6. The stop pin 10 has a pin tip 101 which can be inserted into the locating notch 9, such that the first rotary shaft 5 or the second rotary shaft 6 can be fixed.

Preferably, the first stop pin and the second stop pin are provided with an elastic element, respectively, for exerting force in directions of the first locating notch 9 and the second locating notch 9 on the first stop pin and the second stop pin.

As shown in FIG. 6, the elastic element includes a spring 102 one end of which is fixed to the support beam 21 or the vertical plate 11 and the other end of which is connected to the stop pin. In such a manner, under the elastic force of the spring 102, the stop pin can be located at the locating notch 9. When there is a need to rotate the first rotary shaft 5 or the second rotary shaft 6, only a force is exerted on the stop pin against the spring 102 to release the pin tip 101 from the locating notch 9.

Preferably, the rotary rack 22 includes a primary support bar 221 and auxiliary support bars 222 which are arranged perpendicularly to the primary support bar 221; and the rotary rack 22 is symmetrical about the second rotary shaft 6. In such a manner, the rotary rack 22 can be more stably rotated.

As shown in FIGS. 7-9, preferably, the access support 3 includes a top side 31 for placing the substrate thereon and periphery sides 32 surrounding the top side 31. The common border between the top side 31 and at least one of periphery sides adjacent to the vertical plate 11 has a gap 321 for the support beam 21 to pass through. In such a manner, the access support 3 can ascend or descend without the interference of the support beam 21.

Preferably, opposite borders of the top side 31 has a plurality of additional rods 311, respectively, which are arranged at intervals and extended inwardly; a clearance 312 is defined between two oppositely arranged additional rods 311 for the primary support bar 221 to pass through; and a spacer region 313 is defined between two adjacent additional rods 311 on the same border for the auxiliary support bars 222 to pass through.

Since the clearance 312 is formed between two oppositely arranged additional rods 311 and the spacer region 313 is formed between two adjacent additional rods 311 on the same border, the primary support bar 221 and the auxiliary support bars 222 of the rotary rack 22 can ascend or descend without interfering with the access support 3.

The substrate can be placed on the transmission support 4 as shown in FIG. 9. When the substrate is normally transmitted, the access support 3 is positioned under the transmission support 4. When there is a need to transfer the substrate to another apparatus, the access support 3 ascends by the lifting unit (which could be gas cylinder or hydraulic cylinder drive), so as to hold the substrate up. In the meanwhile, the substrate is supported by a plurality of additional rods 311. The movable support 2 is moved to the underneath of the access support 3. Then, the movable support 2 ascends by the lifting unit, In such a manner, the substrate is transferred to the movable support 2 and supported by the movable support 2. Then, the substrate can be moved to other apparatus.

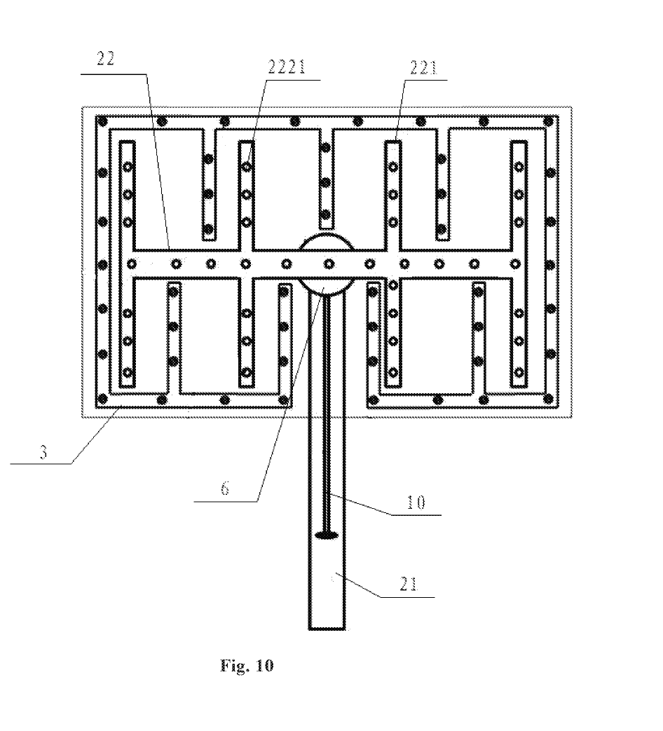

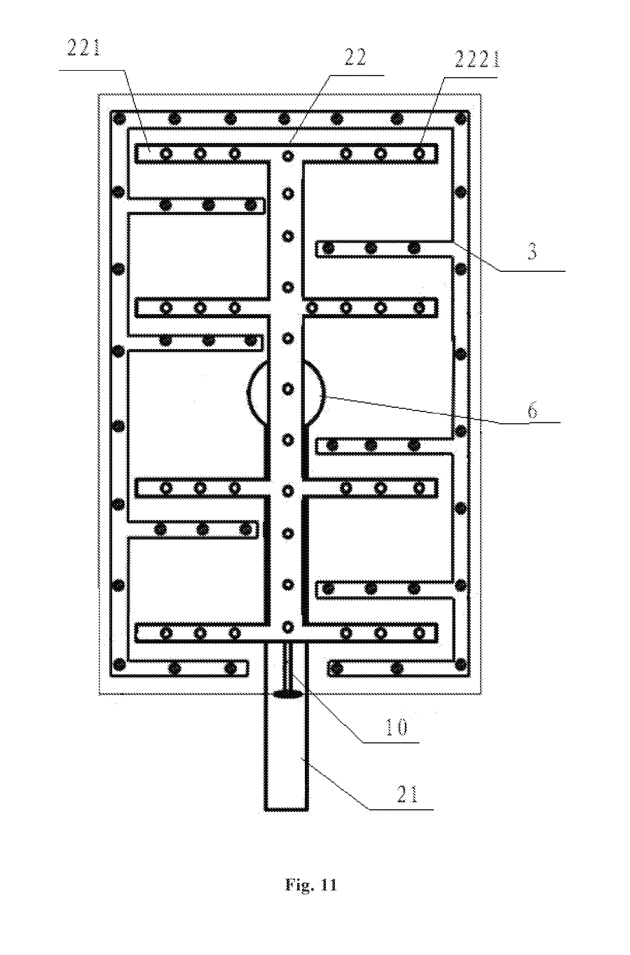

Preferably, as shown in FIGS. 10 and 11, the auxiliary support bars 222 are provided with a plurality of adsorption parts 2221 for adsorbing the substrate.

It should be understood that the adsorption parts 2221 can be uniformly distributed on the auxiliary support bars 222. The adsorption parts 2221 are connected to a vacuum generator (for example, a vacuum pump), and a switch of the adsorption parts 2221 between a vacuum state and a normal pressure state can be completed by means of a control valve.

Hereinafter, operation process of the transfer device for substrate will be described in brief.

The substrate is placed on the transmission support 4. When the substrate is normally transmitted, the access support 3 is positioned under the transmission support 4. When there is a need to transfer the substrate to another apparatus, the access support 3 ascends by the lifting unit (which could be gas cylinder or hydraulic cylinder drive), so as to hold the substrate up. In the meanwhile, the substrate is supported by a plurality of additional rods 311.

The support body 1 is moved to the underneath of the access support 3.

The movable support 2 is moved to the underneath of the access support 3. Then, the movable support 2 ascends by the lifting unit. In such a manner, the substrate is transferred to the movable support 2 and supported by the movable support 2. Based on the structure according to the embodiment of the disclosure, the movable support 2 and access support 3 may not interfere with each other.

The rotary rack 22 of the movable support 2 can adsorb the substrate by means of the adsorption parts 2221. The substrate can be rotated with the rotation of the second rotary shaft 6. In particular, while the stop pin 10 is pulled in a direction away from the second rotary shaft 6, the rotary rack 22 is rotated; when it is rotated an appropriate angle (for example, 90 or 180 degrees), the stop pin 10 is released, such that the stop pin 10 is moved towards the second rotary shaft 6 under the action of the spring 102 and a pin tip 101 of the stop pin 10 is inserted into the locating notch 9.

When there is a need to flip over or rotate the substrate about the support beam 21 as an axis, the first rotary shaft 5 and the locating disk 7 can be used to flip over or rotate the substrate in a similar manner to above description.

The support body 1 is moved to another apparatus. Then, the rotary rack 22 descends such that the substrate is brought into contact with a support surface of the apparatus. The vacuum pump is switched off to transfer the substrate to the apparatus.

It should be understood that the above embodiments are merely exemplary embodiments for the purpose of illustrating the principle of the invention, and the invention is not limited thereto. Various modifications and improvements can be made by a person having ordinary skill in the art without departing from the spirit and the essence of the invention. Accordingly, all of the modifications and improvements also fall into the protection scope of the invention.

1. A transfer device for substrate, including: a support body, a movable support connected to the support body, and an access support for cooperating with the movable support to pick up and place the substrate, the support body including a vertical plate and a bottom plate which are perpendicular to each other, wherein
the movable support includes a support beam rotatably connected to the support body;
the movable support further includes a rotary rack rotatably connected to the support beam;
the rotary rack is configured to drive the substrate to rotate within a plane of the rotary rack; and
the support beam is configured to drive the substrate on the rotary rack to flip over.

2. The transfer device for substrate according to claim 1, wherein
the support beam is connected to the support body via a first rotary shaft, such that the support beam is able to rotate about the first rotary shaft with respect to the support body.

3. The transfer device for substrate according to claim 1, wherein
the rotary rack is connected to the support beam via a second rotary shaft, such that the rotary rack is able to rotate about the second rotary shaft with respect to the support beam.

4. The transfer device for substrate according to claim 3, wherein
the rotary rack is able to move in a longitudinal direction of the support beam to adjust a distance between the rotary rack and the support body.

5. The transfer device for substrate according to claim 4, wherein
a sliding slot is provided on the support beam in the longitudinal direction; and
the second rotary shaft is able to fit to the sliding slot at one end thereof and move along the sliding slot.

6. The transfer device for substrate according to claim 5, wherein
the sliding slot further includes an internal expansion space which is expended inside the support beam along a width direction; and
the second rotary shaft includes a flange which is fitted to the internal expansion space.

7. The transfer device for substrate according to claim 2, wherein
the first rotary shaft is provided with a first locating disk between the support body and the support beam;
the first locating disk includes a plurality of locating notches arranged in a peripheral direction thereof; and
a first stop pin is provided on the support body, such that a rotation angle of the first rotary shaft is controlled by the cooperation between the first stop pin and the locating notches.

8. The transfer device for substrate according to claim 3, wherein
the second rotary shaft is provided with a second locating disk between the rotary rack and the support beam;
the second locating disk includes a plurality of locating notches arranged in a peripheral direction thereof; and
a second stop pin is provided on the support beam, such that a rotation angle of the second rotary shaft is controlled by the cooperation between the second stop pin and the locating notches.

9. The transfer device for substrate according to claim 7, wherein
the first stop pin is provided with an elastic element for exerting force in direction of the first locating notch on the first stop pin.

10. The transfer device for substrate according to claim 8, wherein
the second stop pin is provided with an elastic element for exerting force in direction of the second locating notch on the second stop pin.

11. The transfer device for substrate according to claim 3, wherein
the rotary rack includes a primary support bar and auxiliary support bars which are arranged perpendicularly to the primary support bar; and
the rotary rack is symmetrical about the second rotary shaft.

12. The transfer device for substrate according to claim 11, wherein
the auxiliary support bars are provided with a plurality of adsorption parts for adsorbing the substrate.

13. The transfer device for substrate according to claim 1, wherein
the access support includes a top side for placing the substrate thereon and periphery sides surrounding the top side; and
a common border between the top side and at least one of periphery sides adjacent to the vertical plate has a gap for the support beam to pass through.

14. The transfer device for substrate according to claim 13, wherein
opposite borders of the top side has a plurality of additional rods, respectively, which are arranged at intervals and extended inwardly;
a clearance is defined between two oppositely arranged additional rods for the primary support bar to pass through; and
a spacer region is defined between two adjacent additional rods on the same border for the auxiliary support bars to pass through.
